(19) United States
(12) Patent Application Publication
(10) Pub. No.: US 2014/0358630 A1
(43) Pub. Date: Dec. 4, 2014

(54) APPARATUS AND PROCESS FOR CONDUCTING SOCIAL MEDIA ANALYTICS

(71) Applicant: THOMSON LICENSING, Issy de Moulineaux (FR)

(72) Inventors: Smriti Bhagat, San Francisco, CA (US); Anmol Nalin Sheth, San Francisco, CA (US); Sandilya Bhamidipati, Palo Alto, CA (US)

(21) Appl. No.: 14/290,058

(22) Filed: May 29, 2014

Related U.S. Application Data
(60) Provisional application No. 61/829,635, filed on May 31, 2013.

(51) Int. Cl. G06Q 30/02

(52) U.S. Cl. CPC G06Q 30/0201; G06Q 50/01
USPC 705/7.29

(57) ABSTRACT

A system, apparatus and method for performing social media analytics for a movie are provided. The present disclosure provides for a social media analytics platform that builds a rich landscape of interests of movie audiences by mining data from social networking or microblogging services, such as Twitter™. The present disclosure provides for associating at least one user with a movie; collecting, for the at least one associated user, at least one of user location data, user interest data, user-cited website data, and user television viewing habits data from a social networking or microblogging service; processing the collected data to generate movie campaign data, the movie campaign data including at least one of movie marketing data, movie advertising data, and movie distribution data; and providing the at least one movie marketing data, movie advertising data, and movie distribution data for display in a user interface.

### REFERENCE TO RELATED PROVISIONAL APPLICATION

This application claims priority from provisional application No. 61/829,635 filed on May 31, 2013, the contents of which are hereby incorporated by reference in its entirety.

### TECHNICAL FIELD

The present disclosure relates to a social media analytics platform that builds a rich landscape of interests of movie audiences by mining data from social networking or microblogging services.

### BACKGROUND ART

Characterizing a movie audience is relevant for a variety of decisions made by movie studios, marketers, distributors, etc. More specifically, characterizing the movie audience can facilitate an understanding about what geographic locations the movie should be marketed in, what websites should online ad campaigns for the movie target, and which celebrities' endorsements for the movie should be solicited.

As a result, studios, marketers, distributors and the like go to great extent in characterizing their audiences using a variety of sources such as Nielsen reports, online surveys, interviewing people outside the movie theatres and using trained experts to analyze these interviews, and purchasing market profiling data from companies (e.g., Rentrak Corporation of Portland, Oreg.). However, there are drawbacks to using these sources or approaches. For example, these approaches are often not scalable, not cost effective, and do provide fairly limited insight into the movie audiences. In general, studios, marketers and distributors currently lack a direct connection with their audience and resort to ad hoc approaches to understanding their audience. Consequently, existing tools can only quantify the buzz around the movie and do not provide a detailed characterization of the audiences.

Therefore, a need exists for techniques for a data analytics service to characterize the interests of movie audiences and to generate movie campaign data from such data.

### SUMMARY

A system, apparatus and method for performing social media analytics for a movie are provided.

According to one aspect of the present discourse, a method includes associating at least one user with the movie, collecting, for the at least one associated user, at least one of user location data, user interest data, user-cited website data, and user television viewing habits data from a social networking or microblogging service, processing the collected at least one user location data, user interest data, user-cited website data, and user television viewing habits data to generate movie campaign data, the movie campaign data including at least one of movie marketing data, movie advertising data, and movie distribution data, and providing for display the at least one movie marketing data, movie advertising data, and movie distribution data in a user interface.

According to another aspect of the present disclosure, an apparatus for performing social media analytics for a movie includes a social media analytics module that associates at least one user with the movie, collects, for the at least one associated user, at least one of user location data, user interest data, user-cited website data, and user television viewing habits data from a social networking or microblogging service, and processes the collected at least one user location data, user interest data, user-cited website data, and user television viewing habits data to generate movie campaign data, the movie campaign data including at least one of movie marketing data, movie advertising data, and movie distribution data, and a data visualizer that provides for display the at least one movie marketing data, movie advertising data, and movie distribution data in a user interface.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

FIG. 1 is a block diagram of a system in accordance with the present disclosure;

FIG. 2 is a block diagram of a social media analytics platform in accordance with the present disclosure;

FIG. 3 is flowchart for an exemplary method for performing social media analytics for a movie in accordance with the present disclosure;

FIG. 4 is flowchart for an exemplary method for resolving a location of a user of a social networking or microblogging service in accordance with the present disclosure;

FIG. 5 is flowchart for an exemplary method for inferring interest of a user of a social networking or microblogging service in accordance with the present disclosure;

FIG. 6 depicts an exemplary graphical user interface associated with the system of FIG. 1;

FIG. 7 depicts another view of the exemplary graphical user interface shown in FIG. 6;

FIG. 8A depicts an exemplary graphical user interface associated with the system of FIG. 1;

FIG. 8B depicts another view of the exemplary graphical user interface shown in FIG. 8A;

FIG. 9 is flowchart for an exemplary method for classifying a movie in accordance with the present disclosure;

FIG. 10A illustrates trends of user followers for a plurality of movies in accordance with the present disclosure;

FIG. 10B illustrates representative clusters of the time series trends shown in FIG. 10A;

FIG. 11A depicts an exemplary graphical user interface associated with the system of FIG. 1;

FIG. 11B illustrates results comparing the performance of the location determination of the present disclosure against conventional location determination methods;

FIG. 12 depicts an exemplary graphical user interface associated with the system of FIG. 1;

FIG. 13 depicts an exemplary graphical user interface associated with the system of FIG. 1;

FIG. 14 depicts an exemplary graphical user interface associated with the system of FIG. 1;

FIG. 15 depicts an exemplary graphical user interface associated with the system of FIG. 1; and

FIG. 16 depicts an exemplary graphical user interface associated with the system of FIG. 1.

It should be understood that the drawings are for purposes of illustrating the concepts of the disclosure and is not necessarily the only possible configuration for illustrating the disclosure.

### DETAILED DESCRIPTION

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for instructional purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure provides for a social media analytics platform that builds a rich landscape of interests of movie audiences by mining data from social networking or microblogging services, such as Twitter™. The social media analytics platform provides detailed insights into the movie audiences including, but not limited to, who is the audience (their demographics, profession), what are their interests, what do they read and talk about, what TV shows do they watch, and who do they follow. The social media analytics platform can help a customer or end user understand various audience related information such as, but not limited to, the target audience for advertising campaigns, location scouting based on audience location, the evolution of audience interests over time (e.g., at pre-release, opening weekend, after movie is a hit), which TV shows the audience is interested in, what brands are of interest to the audience for product placement, and the like. In addition, the social media analytics platform can be used to aid the decision making process for a movie's life cycle. A movie, as used herein, includes, but is not limited to, full length movies, movie trailers of varying lengths (e.g., 5 second teasers, 30 second trailers, 60 second trailers, 90 second trailers, etc.) and for various venues (e.g., theaters, tv spots, internet web sites, etc.), and movie-related advertisements for television and the internet. The movie may be consumed in, but not limited to, theaters, home entertainment systems (e.g., TVs, computers, etc.), portable devices (e.g., tablets, lap tops, phones, etc.) and the like.

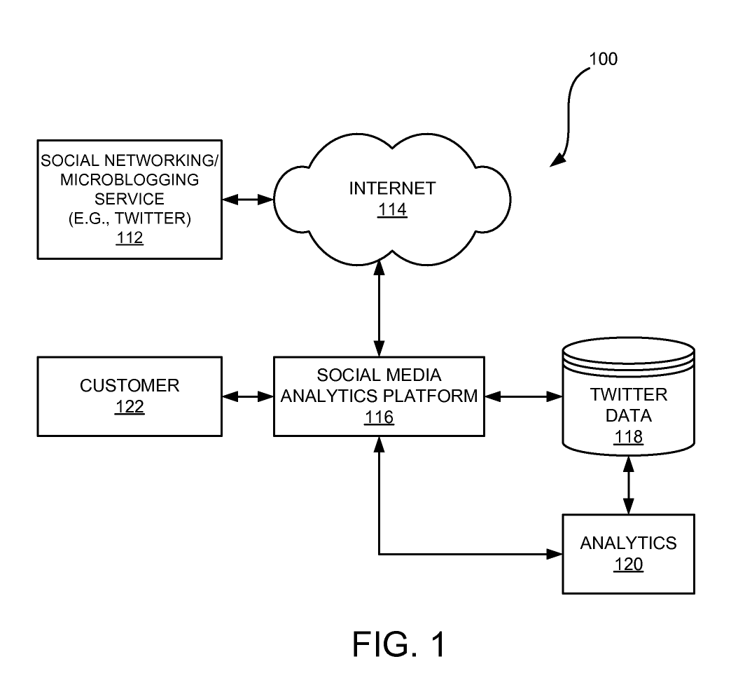

FIG. 1 depicts a block schematic diagram of a system 100 in accordance with the present disclosure. The system 100 includes an online social networking and microblogging service 112, such as, but not limited to, Twitter™, Facebook™, Google+™, Instagram™, etc., that enables its users to send and read text-based messages (in the case of Twitter™ these messages are known as “tweets”). Over the last few years, Twitter™ has become the dominant platform that captures a large fraction of online discussions and chatter about movies. This makes Twitter™ a great observation tool that enables the system and method of the present disclosure to profile movie audiences.

System 100 also includes the Internet 114 which connects a social media analytics platform 116 (also known as AudienceScape) to the online social networking and microblogging service 112, as well as a database 118 for storing data collected from the online social networking and microblogging service 112 and analytics tools 120 for processing and analyzing the collected data stored in the database 118. The social media analytics platform 116, using the analytics tools 120 for processing and analyzing the collected data stored in the database 118, analyzes the collected data and uncovers the interests and demographics of movie audiences. The social media analytics platform 116, analytics tools 120 and database 118 may reside on separate modules, may be integrated into a single module, and may be embodied in a computer system, desktop, laptop, tablet, smart phone, gateway, or the like separately or in combination as known by those skilled in the art. Once the collected data has been processed by the social media analytics platform 116 and analytics tools 120, feedback can be provided back to a customer 122. Some examples of customers include, but are not limited to, studios, advertisers, advertising agencies, and the like.

It should be noted that the social media analytics platform 116 has two key characteristics that are complementary to existing solutions in the market: First, the social media analytics platform 116 is cost-effective and scalable. Unlike services like Nielsen that conduct surveys and monitors user's TV watching habits, the social media analytics platform 116 is scalable and can rapidly engage a large number of users at a fraction of a cost as compared to Nielsen. Second, the social media analytics platform 116 provides detailed characterization. Unlike other services like NeoLedge that primarily quantify the amount of buzz a movie generates, the social media analytics platform 116 provides a detailed characterization of the interests of movie audiences.

The main challenge in building the social media analytics platform 116 is dealing with the noisy data generated by the users on social networking and microblogging services such as Twitter™. Other challenges addressed by the social media analytics platform 116 include:
1. Location analysis: Tweets are rarely geo-tagged (<1% of tweets are geo-tagged) and the social media analytics platform 116 extracts location data from text that the user inputs manually. This is often noisy and so the social media analytics platform 116 utilizes techniques to clean up the location data to geo-locate the users.
2. Audience Interests/Professions/Hobbies: This information is extracted by mining biography text that a user inputs when creating the social networking and microblogging services account, e.g., a Twitter™ user profile, which is often noisy.
3. Online interests: While it may not be feasible to track Twitter™ users online, the social media analytics platform 116 relies on the URLs (uniform resource locator) contained within a user's tweets to estimate the websites that users visit often. Furthermore, by analyzing the content of the URLs posted on Twitter™, the social media analytics platform 116 can also estimate the specific topics that users browse online.
4. Audience TV watching habits: The social media analytics platform 116 analyzes users' second screen activity on Twitter™ to learn about their TV watching habits.

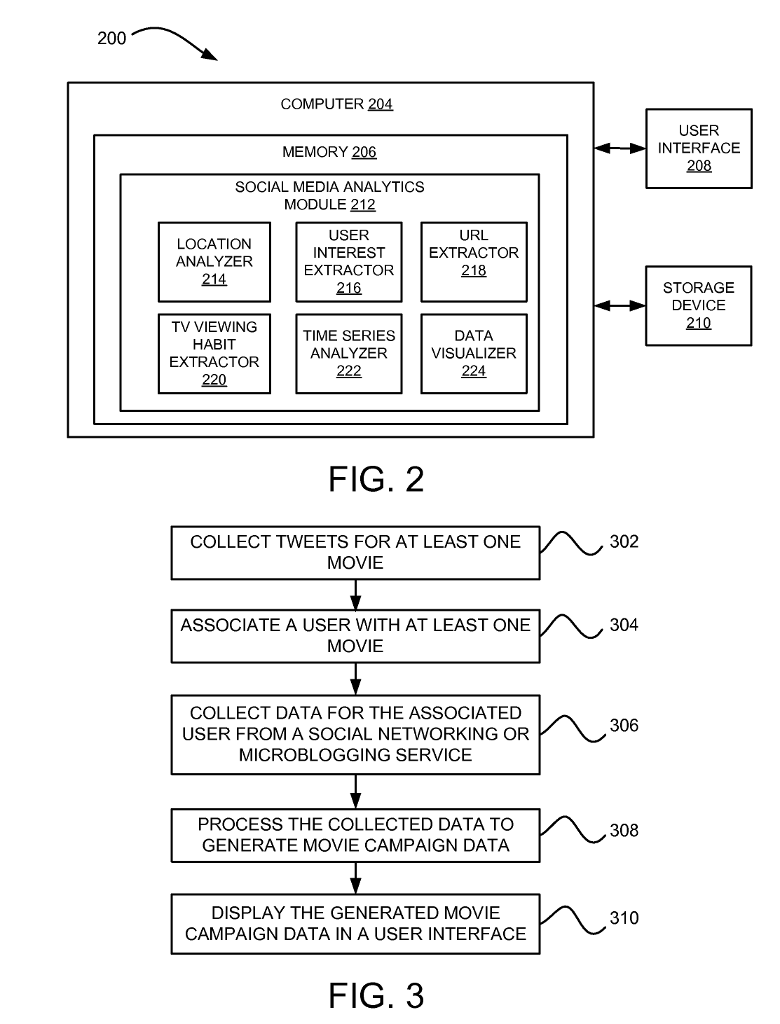

Referring FIG. 2, exemplary components of the social media platform 116, embodied as apparatus 200, are shown. The messages generated on the social networking or microblogging services, e.g., tweets, are input to a processing device 204, e.g., a computer. The computer is implemented on any of the various known computer platforms having hardware such as one or more central processing units (CPU), memory 206 such as random access memory (RAM) and/or read only memory (ROM) and input/output (I/O) user interface(s) 208 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as processing device 204. In addition, various other peripheral devices may be connected to the computer platform by various interfaces and bus structures, such a parallel port, serial port or universal serial bus (USB). Other peripheral devices may include additional storage devices 210 and a printer (not shown). It is to be appreciated that storage device 210 may store the data collected from the social networking or microblogging service 112 in a database such as database 118 shown in FIG. 1.

A software program includes a social media analytics module 212 stored in the memory 206 for performing social media analytics for movie. The social media analytics module 212 generally processes a plurality of messages generated on a social networking or microblogging service (in one embodiment, the messages are also known as “tweets”) and groups the message related to a particular movie. The social media analytics module 212 then processes the grouped messages to associate a user who generated the message to the particular movie.

The social media analytics module 212 includes a location analyzer 214 for determining the location of the user or the location of where the message was originated from. A user interest extractor 216 is provided to extract or infer interests of a user based on a profile of the user. In one embodiment, the user interest extractor 216 extracts the user's interest by a keyword based extraction method, the details of which will be described below. In another embodiment, the user interest extractor 216 infers the user's interest via a hierarchical labeling method, the details of which will be described below.

The social media analytics module 212 further includes a URL extractor 218 for extracting URLs (uniform resource locator) from a message generated by a user. A TV viewing habit extractor 220 is provided for determining television viewing habits of a user. The TV viewing habit extractor 220 is configured to extract labeled terms from a message generated by a user. For example, a name of a television show, character name, or actor name labeled with a metadata tag such as a hashtag (#).

A time series analyzer 222 is provided for analyzing a plurality of messages overtime. The time series analyzer 222 further includes a k-means clustering algorithm or function for generating representative clusters of time series trends for classifying movies, the details of which will be described below.

Additionally, a data visualizer 224 processes the data to generate a graphical user interface for presenting the data and results to a customer 122 via the user interface 208. It is to be appreciated that the data visualizer 224 will generate various graphical user interfaces depending on the device the interface is being displayed upon, e.g., a monitor, tablet, smartphone, etc.

It is to be appreciated that the location analyzer 214, user interest extractor 216, URL extractor 218, TV viewing habit extractor 220 and time series analyzer 222 may collective be referred to as the analytics tools 120, as shown in FIG. 1. It is further to be appreciated that the analytics tools 120 may include all the components shown in FIG. 2, a subset of the components or additional components not shown.

Referring now to FIG. 3, an exemplary process in accordance with the present disclosure is shown. The process continuously collects data from an online social networking and microblogging service 112 such as Twitter™, and then extracts location and interest information of audience to generate movie campaign data.

Initially, in step 302, the social media analytics platform 116 accesses a social networking or microblogging service 112 and collects messages related to at least one movie. In step 304, the social media analytics module 212 associates a user that generated the message to the at least one movie by separating the collected messages, for example, into individual user buckets. Next, the social media analytics module 212 collects from the collected message at least user location data via the location analyzer 214, user interest data via the user interest extractor 216, user-cited website data via the URL extractor 218, and user television viewing habits data via the TV habit extractor 220, step 306.

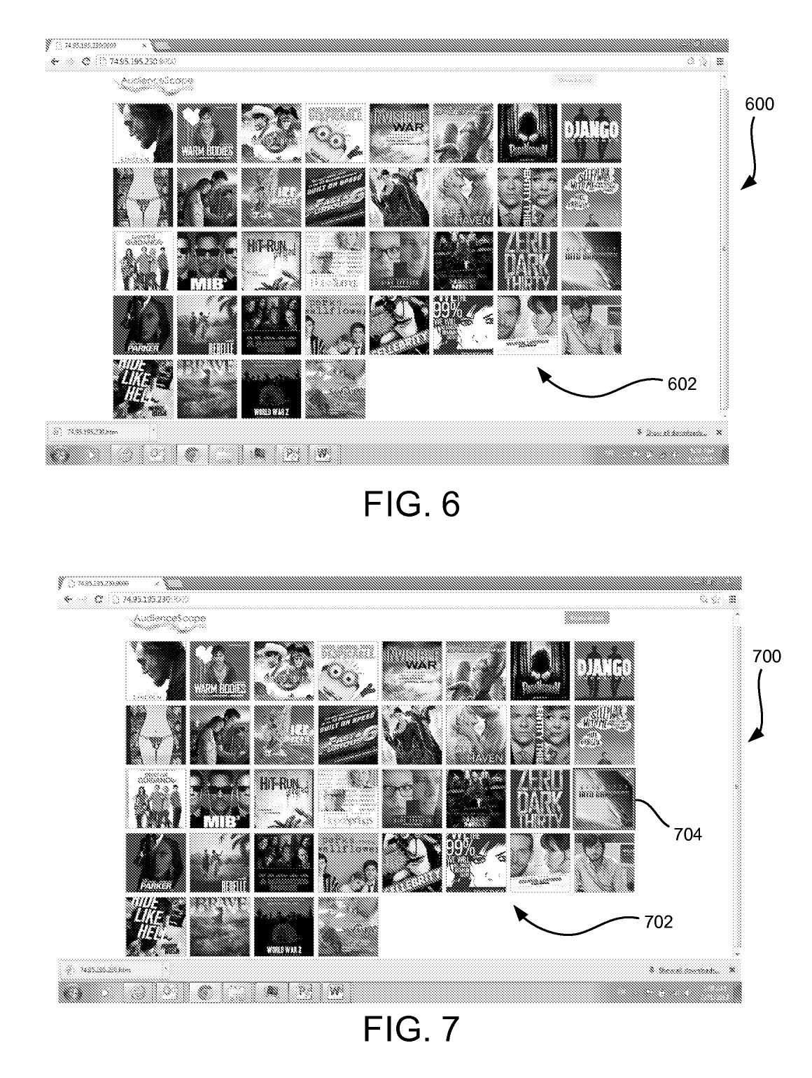

Then, in step 308, the collected at least one user location data, user interest data, user-cited website data and user television viewing habits data are processed to generate movie campaign data via the social media analytics module 212 and time series analyzer 222. The movie campaign data includes at least one of movie marketing data, movie advertising data, and movie distribution data. In step 310, the data visualizer 224 displays the generated movie campaign data in an appropriate user interface, the details of which will be described below in relation to FIGS. 6-16.

Various processes to collect data from the message for the associated user will now be described.

Achieving spatial analysis, i.e., location data, from Twitter™ data requires addressing the following challenges:
1. Only a small fraction (1%) of tweets are geo-tagged. Consequently, the users location is determined by the free-text description of the location attribute of their user profile entered by the user when signing up with the social networking or microblogging service. Note that users may also manually edit these location fields, e.g., a user moves to a different city.
2. IP based geo-location is ruled out as IP addresses are not exposed by Twitter™.
3. Existing commercial geo-coders, that resolve a user's location from free text, are expensive and cannot scale to the large number of movie audiences.
   To address these challenges, the social media analytics platform 116 extracts user location from free-text with the following key characteristics: location analyzer 214 can resolve the location between multiple possible locations accurately, e.g., France, Liverpool; the location analyzer 214 can resolve maximum entries to the city level; and location analyzer 214 is fast and can scale to millions of users while achieving an accuracy comparable to existing commercial geo-coders.

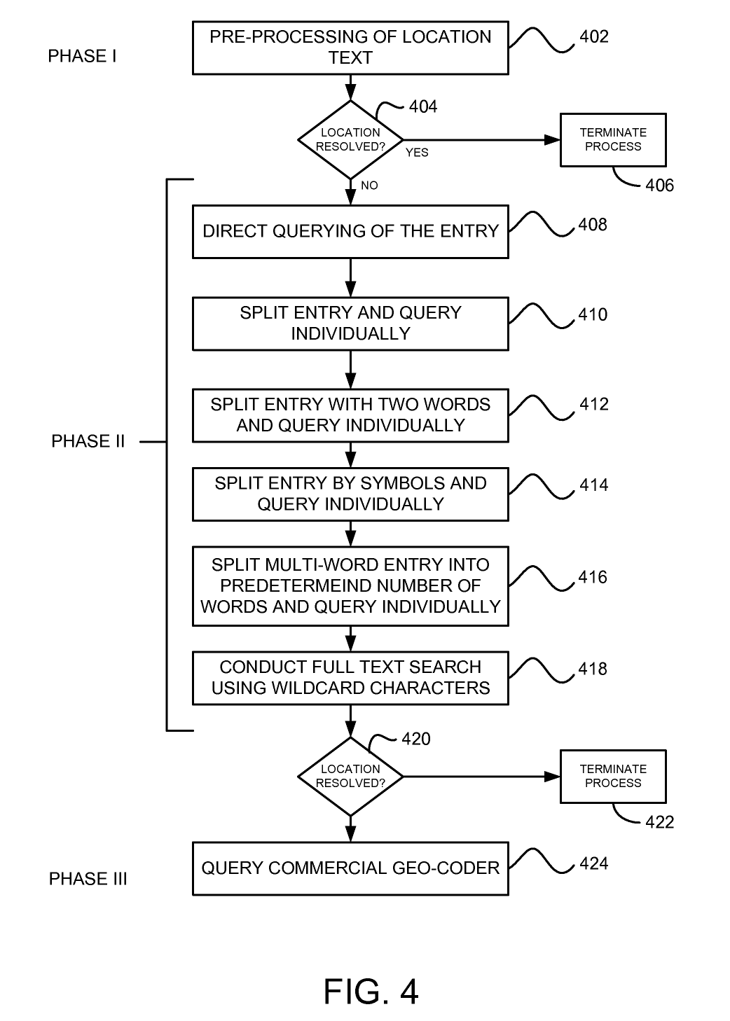

Referring to FIG. 4, an exemplary method for resolving a location of a user of a social networking or microblogging service, via location analyzer 214, is illustrated. The location analysis pipeline executed by the location analyzer 214 has three primary phases.

### Phase 1: Pre-Processing of Location Text

In this phase, step 402, regular expressions statements are used to remove stopwords, smileys, repetitive punctuations and extra whitespaces from the location entry of the user profile. Additionally, entries with latitude-longitude coordinates (for the 1% of tweets that are geo-coded) and zip codes are extracted, and queried separately to identify the location directly. If the location is resolved at this phase, step 404, the process is terminated, step 406.

### Phase 2: Processing Pipeline of Location Text

This phase is designed as a multi-stage process, terminating at the stage when the location is resolved. At each stage in this phase, locations are disambiguated using the user's time zone information mentioned in the Twitter™ profile and using a location with a higher population. Also, at each stage, the pipeline matches the location field entry (after preprocessing) with the actual name of the place, ascii version of the name and all alternate names available. The stages are:
a) Direct querying of the location entry (e.g., Los Angeles) (step 408)
b) The location entry is split by commas and queried individually. A check to ensure country match (and additionally, state match in case of U.S.) is done and only results satisfying this criterion are considered. (e.g., Stanford, Calif. and London, England). (step 410)
c) Same technique is also employed to resolve entries with two words, where second word is a higher administrative zone (country/state) (step 412)
d) Entry is split by any of {+, /, ‘and’, ‘or’} and queried separately (e.g., Newyork/Toronto) (step 414)
e) Multi-worded entries are split into a predetermined number of words (e.g., a maximum of 4 words). First, the first word is queried and if not resolved, first two words are queried together. Set of stop words like south, north, new, the, great, etc are avoided to prevent false positives. (e.g., Durban South Africa, San Francisco Calif.) (step 416)
f) Full text search using wildcard characters to resolve entries with spelling errors. Limited to edit Distance of 2 and additionally, results are sorted by increasing edit distance. (e.g., Chicagoo, Atlana) An exact match (brute) search using a list of common location names (e.g., FloridaTexas, TokyoJapan). Cities are preferred over states and stated preferred over countries. (step 418)
   If the location is resolved at this phase, step 420, the process is terminated, step 422.
   Phase 3: Entries not Resolved by the First Two Phases are Resolved by Querying a Commercial Geo-Coder, e.g. Google Maps, in Step 424.
   Once the location is resolved for the user or the particular message, location is associated with the message or the individual user.

People reveal a lot of information about themselves on social media platforms, sometimes with the intent to share their experiences with friends or the public, and others for receiving better personalized services. The information in a user's profile often represents their stable interests, and can be very useful in characterizing these users. Therefore, the system and method of the present disclosure determine the interests of a user from such publicly shared information. A user's interests may be fairly broad, and includes anything that characterizes a user, for instance, a user's profession (manager, banker), social role (mother, girl), fandom (celebrity fans), hobbies (cycling, gaming).

In one embodiment, the user interest extractor 216 matches profile keywords with a standard list of user data to extract certain interest. For example, if the user interest extractor 216 is attempted to determine a profession of the user, the user interest extractor 216 matches profile keywords with a standard list of professions from the labor department. The user interest extractor 216 pulls out words like engineer, chef, writer, etc. A similar process is followed to extract the social roles such as mother, son, or girlfriend; age such as middle-age, teenage; and relationship status such as married, engaged, and so on.

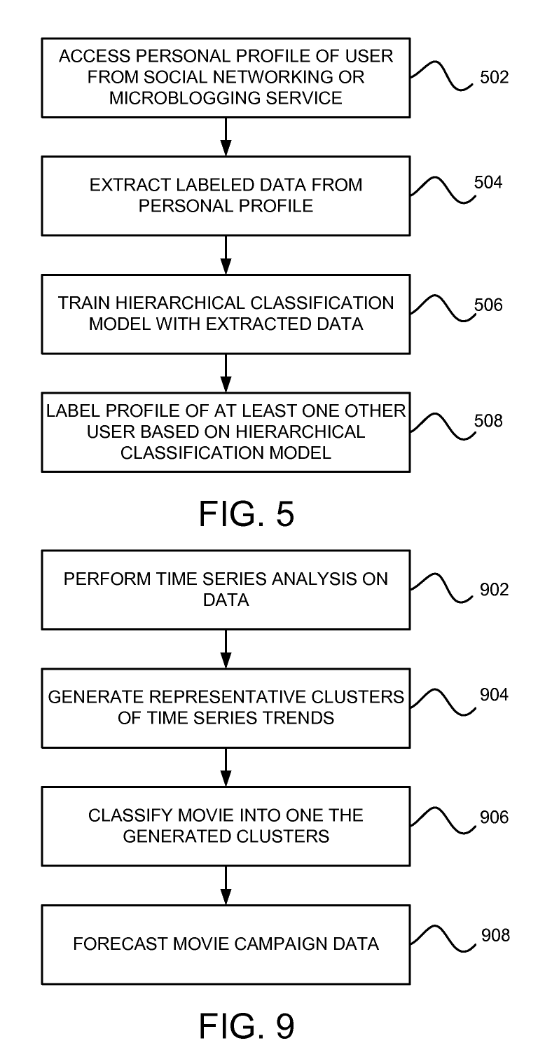

In another embodiment, the user interest extractor 216 infers the interests of a user by analyzing social data, as illustrated in FIG. 5. The user interest extractor 216 approaches the problem of interest extraction as that of a hierarchical labeling problem. Initially, in step 502, the user interest extractor 216 accesses a personal profile of a user. In one embodiment, the user interest extractor 216 make use of a Twitter™ directory service called Twellow™. Users of this service volunteer information about their interests. For instance, a Twitter™ profile stating “I am a musician, producer, songwriter, and foodie from Toronto”, has a corresponding Twellow directory entry with labeled interests “Guitar”, “Musicians”, and “Songwriter”. The main purpose of Twellow is to allow users to register their interests or characteristics, be known for their interests, and potentially connect with other people with similar interest. In step 504, the user interest extractor 216 extracts the labeled interest data from the profile. With this labeled data, user interest extractor 216 trains a hierarchical classification model, step 506. Examples of such a model are Hierarchical Supervised Latent Dirichlet Allocation (HSLDA) classifier, Multilabel classifier, regression based classifier. etc. Using the hierarchical classification model, the user interest extractor 216 predicts and labels the profiles of users that do not explicitly specify their interests in Twellow™ with inferred interest data, step 508. With use of hierarchical classification, the user interest extractor 216 can handle synonyms like author-novelist and also hypernym and hyponym relations e.g., Nascar-Racing, or NBA-Basketball. The user interest extractor 216 can process these results to produce a succinct list of interests per movie. In one embodiment, the user interest extractor 216 combines the information inferred about users into an audience interests profile for a movie by performing frequency analysis along the hierarchy. In addition, the social media analytics module 212 may draw comparisons across movies, to display the audience interests relative to a standard baseline obtained by averaging a set of movies, which may be in the same genre, the same timeframe, or the similar artists.

Referring now to FIG. 6, a home screen 600 of the social media analytics platform 116 is shown. A user (e.g., customer 122) can select one of the images or icons 602 shown on the home screen 600 to see a variety of analytical data about the movie represented by the icon or image. Although not show, a user may also select two or more icons or images to see a comparison of analytical data for the selected movies represented by the icons or images.

Referring now to FIG. 7, at least one movie 704, e.g., the Star Trek Into Darkness movie, has been selected by the user from a plurality of movies 702 on the home screen 700. After the user selects the show movie icon, the variety of analytical data for the Star Trek Into Darkness movie will be shown, as illustrated and discussed in further detail below.

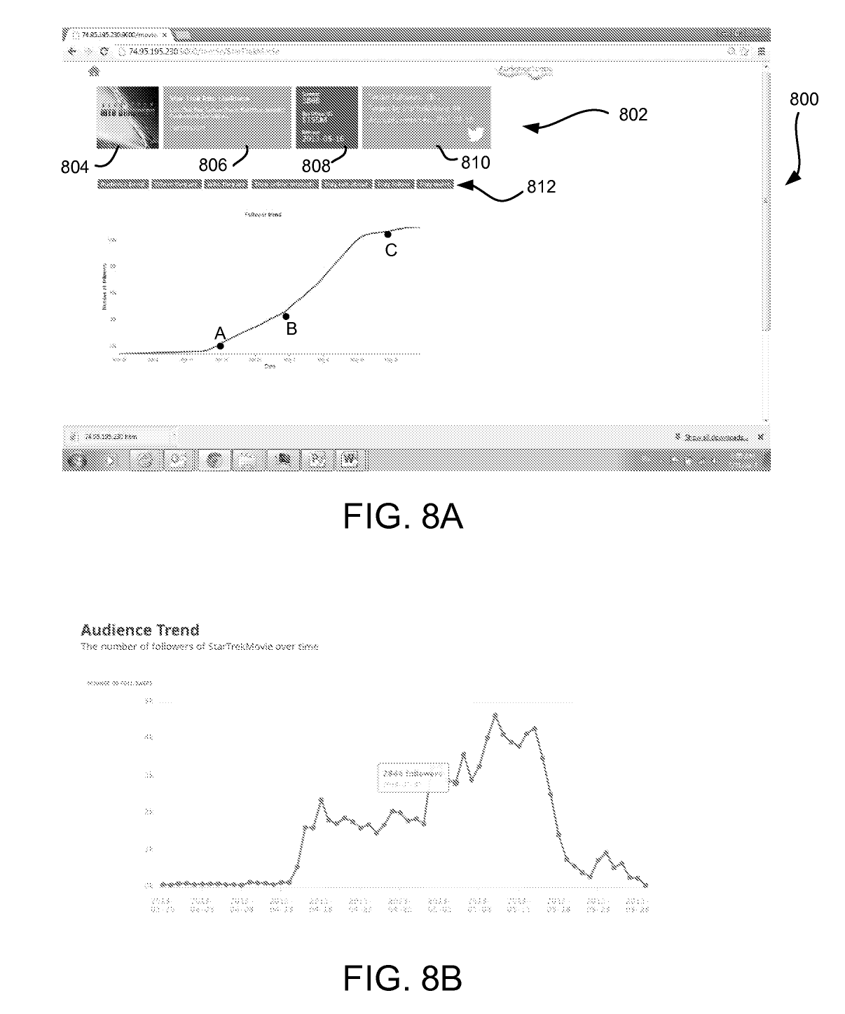

Referring now to FIG. 8A, an audience trend screen 800 of the social media analytics platform 116 is shown. The audience trend screen 800 shows the number of followers of the selected movie over time with key events (e.g., A (official trailer released by the studio before the movie is released), B (movie teasers released), C (movie released)) marked. The audience trend screen 800 is generated from the overall message or tweets collected for a particular movie. Other key events could include, but are not limited to, the start of an advertising campaign or the DVD release of a movie. FIG. 8B depicts another view of the exemplary graphical user interface shown in FIG. 8A.

Temporal analysis of a movie's Twitter™ user growth has several applications. Some of these applications that are relevant to movie studios are: forecast popularity (# of followers) on date of release; predict the post-release trend of evolution; identify similarity in trends across movies; analyze the impact of events or promotions related to the movie; and recommend the timing of promotions and events in order to maximize the follower growth. Therefore, the social media analytics platform 116 uses the temporal analysis of a plurality of movies to predict trends for a movie.

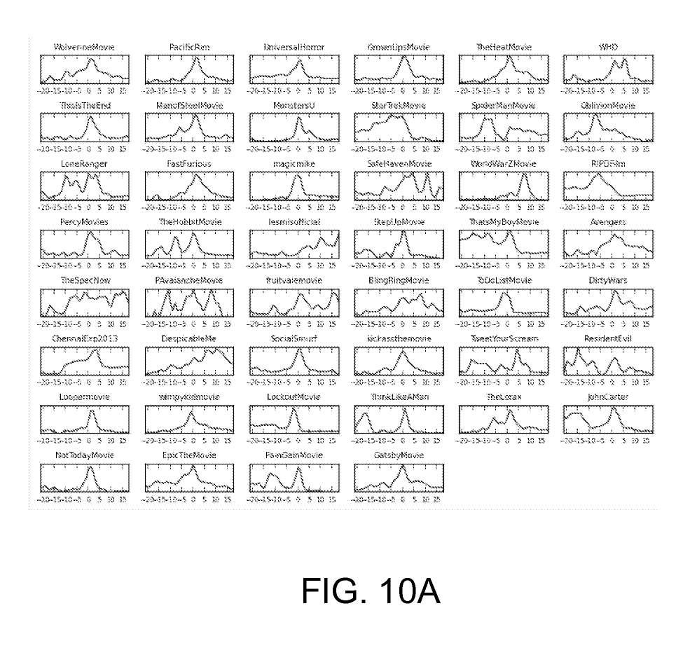

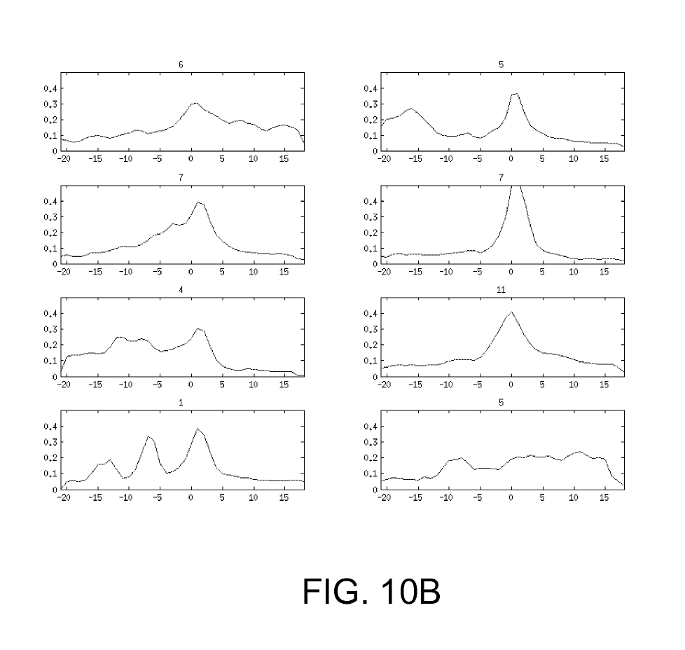

Referring to FIG. 9, a flowchart for an exemplary method for classifying a movie in accordance with the present disclosure is illustrated. In step 902, the time series analyzer 222 performs time series analysis on the audience trend for a plurality of movies. FIG. 10A shows the trend of Twitter™ user followers for 46 different movies for a time period of 20 days before and after the movie release. All traces are normalized and centered on the release of the movie date. The trend indicates the number of users that started following the movie each day. From FIG. 10A, it can be observed that: across all movies, there exists a sharp increase in followers a few days before the release; and there exists other spikes in the trace that correspond to events and promotions scheduled related to the movie.

To forecast and predict such time series data, it was determined that existing time series models do not fit the trends in FIG. 10A. The SpikeM model, which is commonly used to model Twitter™ time series data, was evaluated and was shown that the default SpikeM model did not fit the movie follower time series data for several reason. First, the SpikeM model tries to fit data to a single peak that is modeled with an exponential increase and a power law fall. As seen from the traces, movie follower traces have potentially multiple spikes. Additionally, the SpikeM model assumes periodic spikes. This assumption does not hold as studios (and movie marketers) design promotions and ad campaigns at necessarily scheduled periodically. Further modifications to the SpikeM model to adjust for the periodicity and shifting the trace such to start at a zero value did not lead to significant improvements in the fit.

The time series analyzer 222 employs a k-means clustering of time series using the K-Spectral Centroid (K-SC) algorithm. The time series analyzer 222 uses the K-SC algorithm to generate representative clusters of time series trends, step 904. The K-SC algorithm or function was evaluated using the movie time lines shown in FIG. 10A and the Root Mean Squared Error (RMSE) of the fit was computed using leave one out cross validation approach. This approach resulted in a good fit with an RMSE that was significantly lower than the SpikeM model. The training of the K-SC algorithm using the movie dataset resulted in 8 representative clusters as shown in FIG. 10B. Given these representative clusters shown, a new movie can be classified into one of these clusters, step 906, and the time series can be forecasted to enable the business applications that are important for the studios, step 908.

Referring back to FIG. 8A, a header area 802 of the audience trend screen 800 shows the movie poster 804, cast members and the studio that produced the movie 806. In addition, the movie header 802 also shows the number of theaters 808 that the movie was screened in during, for example, the opening weekend, the total or opening weekend box office collections in the US (shown here) or worldwide, and the number of followers for the movie's social network (e.g., Twitter™) account, the number of time the movie has been mentioned on Twitter™, the tweets by the movie on Twitter™, and the date the studio opened the Twitter™ account for the movie 810. Additional information can be illustrated if the user desires. One potential use for the audience trend screen is to facilitate the user's monitoring of the impact of ad campaigns for the movie.

Additionally, a menu bar 812 is provided for accessing other movie campaign data screens including but not limited to “where they are” screen, “who they are” screen, “their online interests” screen, “they talk about” screen, “they follow” screen and “they watch” screen, the details of which will now be described.

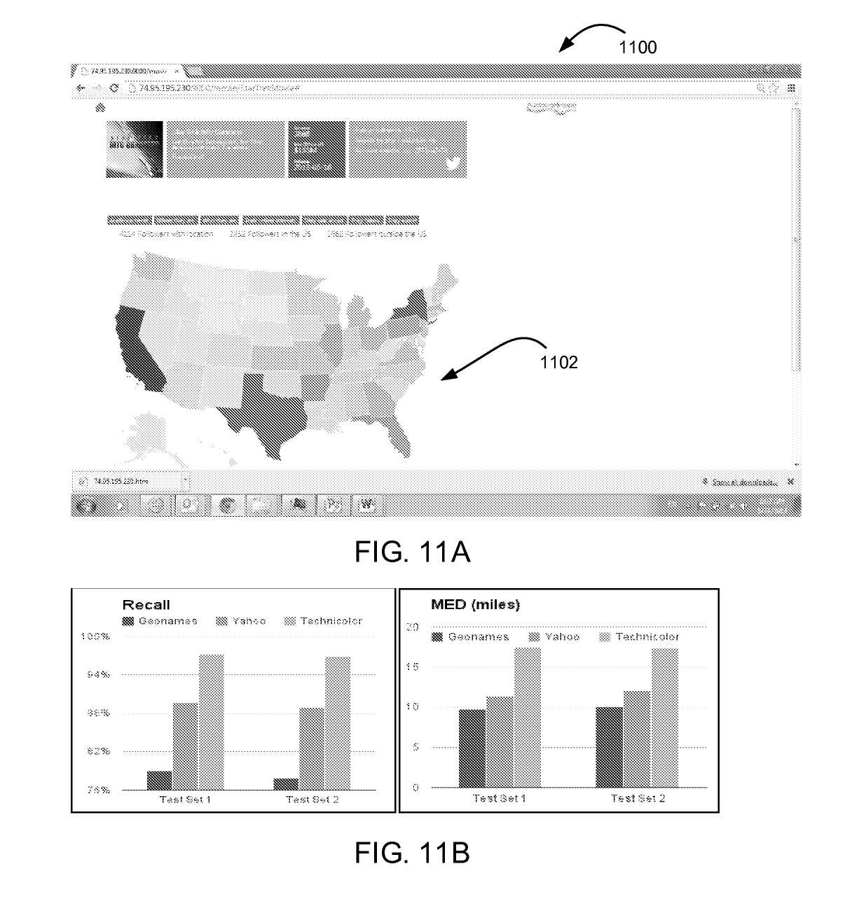

Referring now to FIG. 11A, a “where they are” screen 1100 of the social media analytics platform 116 is shown. It is to be appreciated that the data for the screen 1100 is generated by the location analyzer 214, as described above, and formatted for viewing by the data visualizer 224. The “where they are” screen shows where in the U.S. the followers of the movie reside. The screen includes a heat map 1102 of the states in the U.S. where the darker colored states have a higher number of followers (e.g., a higher number followers of the Star Trek Into Darkness movie reside in California than in Indiana). When the user scrolls or hovers over a given state, the social media analytics platform 116 displays the percentage of followers in that state (e.g., for California the percentage of followers for the Star Trek Into Darkness movie may be 11.56%) and the average across the movies in the social media analytics platform 116 catalog (e.g., for California the average for movies in the social media analytics platform 116 catalog may be 16.66%). Potential uses for the “where they are” screen of the social media analytics platform 116 may include, depending on where the movie's lifecycle is, determining to conduct advertising campaigns in select regions (e.g., states) to increase audience engagement, determining where to conduct promotional campaigns for a movie, determining where to distribute the movie (e.g., sending more instances or copies of the movie to states where there are more followers and less instances or copies of a movie to states where there are less followers).

It is to be appreciated that the data for the screen 1100 is generated by the location analyzer 214, as described above. The above described location analysis pipeline, as described in relation to FIG. 4, was evaluated using Twitter™ bios of movie followers for a total of 16,358 Twitter™ followers of popular movies. The evaluation was performed using three metrics: Recall (% of locations resolved), Median error distance (MED) and Average Error Distance (AED). The results of the location analysis of the present disclosure were compared with tweets that were already geo-tagged. FIG. 11B illustrates the performance of the location pipeline of the present disclosure (i.e., Technicolor) compared to two different commercial services—GeoNames and Yahoo location API. The Technicolor location pipeline provides a significantly higher recall with a modest increase in the median error (10 miles).

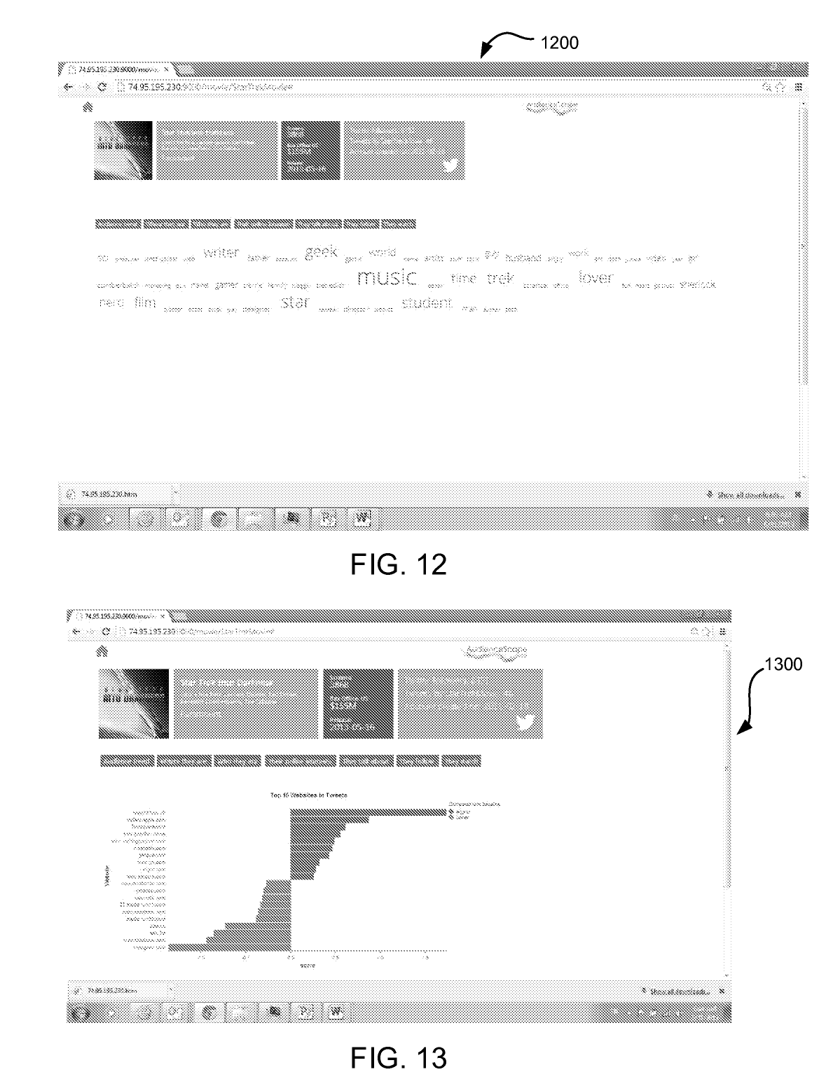

Referring now to FIG. 12, a “who they are” screen 1200 of the social media analytics platform 116 is shown. The “who they are” screen 1200 shows a word cloud of keywords used in followers' descriptions of themselves. Typically, these descriptions include hobbies, professions and interests of the followers. It is to be appreciated that the data for the screen 1200 is generated by the user interest extractor 216, as described above, and formatted for viewing by the data visualizer 224. In one embodiment, the user interest extractor 216 combines the information inferred about users into an audience interests profile for a movie by performing frequency analysis along the hierarchy, as described above in relation to FIG. 5. The audience interests profile is then further processed to create the word cloud shown in FIG. 12. The size of a given word in the word cloud is a function of the number of followers that use the given word. Based on these words, it can be seen that the primary audience for the selected movie, i.e., the Star Trek Into Darkness movie in this example, may be geeks or technical people while a secondary audience for the Star Trek Into Darkness movie may be writers or musicians. Thus, the use of the “who they are” screen 1200 may be to identify secondary target audiences that may not have been consider by customer 122.

Referring now to FIG. 13, a “their online interests” screen 1300 of the social media analytics platform 16 is shown. It is to be appreciated that the data for the screen 1300 is generated by the URL extractor 218, as described above, and formatted for viewing by the data visualizer 224. The “their online interests” screen 1300 shows the top ten websites that have higher and lower activity by followers of the movie compared to a baseline across all movies in the movie catalog of the social media analytics platform 116. The “their online interests” screen 1300 can help inform customers 122 about what websites ad campaigns should be conducted on based on where the movies' audience spends time online.

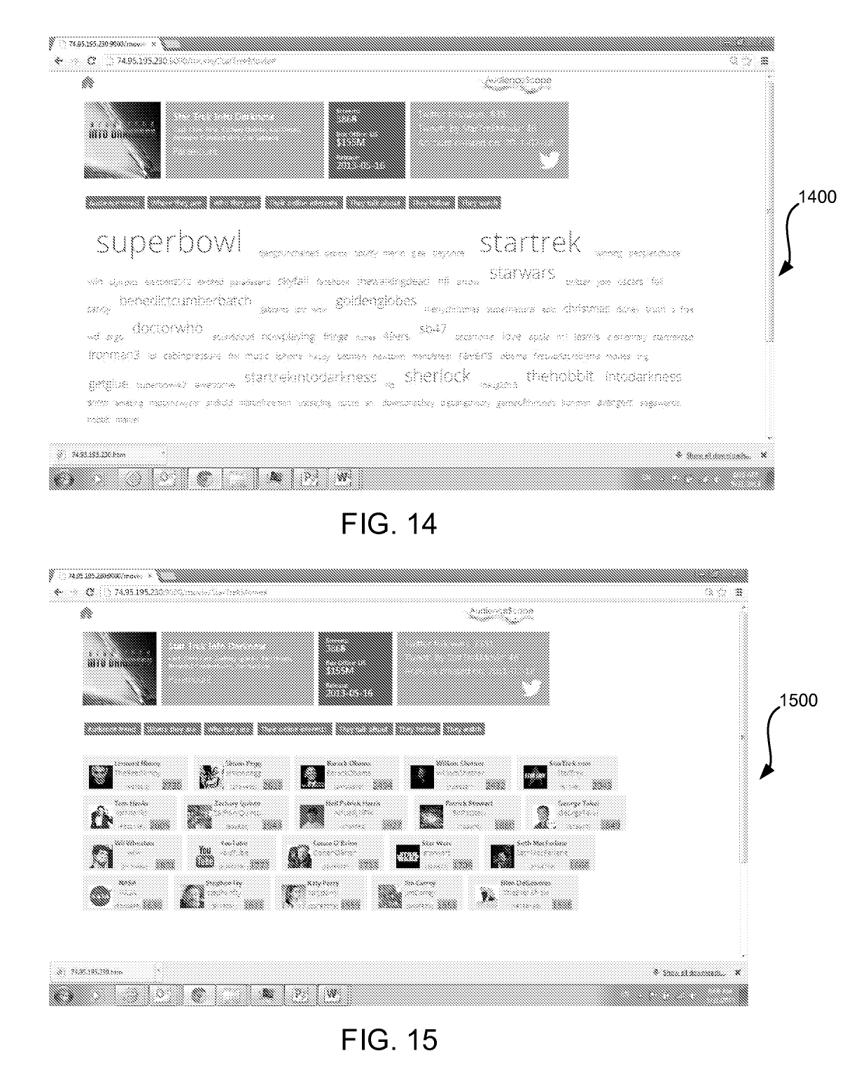

Referring now to FIG. 14, a “they talk about” screen 1400 of the social media analytics platform 116 is shown. The “they talk about” screen 1400 shows a word cloud of keywords (e.g., hashtags) used by the followers of the movie in their tweets. The size of the words in the word cloud is a function of a word's frequency of use. Analyzing this data over time illustrates how topics discussed by followers of the movie change over time. Potential uses of the “they talk about” screen 1400 include identifying brands to be used for product placement or identifying events where movie ads should be placed.

Referring now to FIG. 15, a “they follow” screen 1500 of the social media analytics platform 16 is shown. The “they follow” screen 1500 shows the other Twitter™ accounts followed by those who follow the given movie. Potential uses of the “they follow” screen include, but are not limited to, identifying celebrities to use to advertise and/or endorse the movie, identifying celebrities to use in a road show for the movie, and identifying shows (TV shows or movies) that have some of the cast members of the given movie and that are followed by the audience. It is to be appreciated that the data for the screen 1500 may be generated by the TV viewing habit extractor 220, as described above, and formatted for viewing by the data visualizer 224.

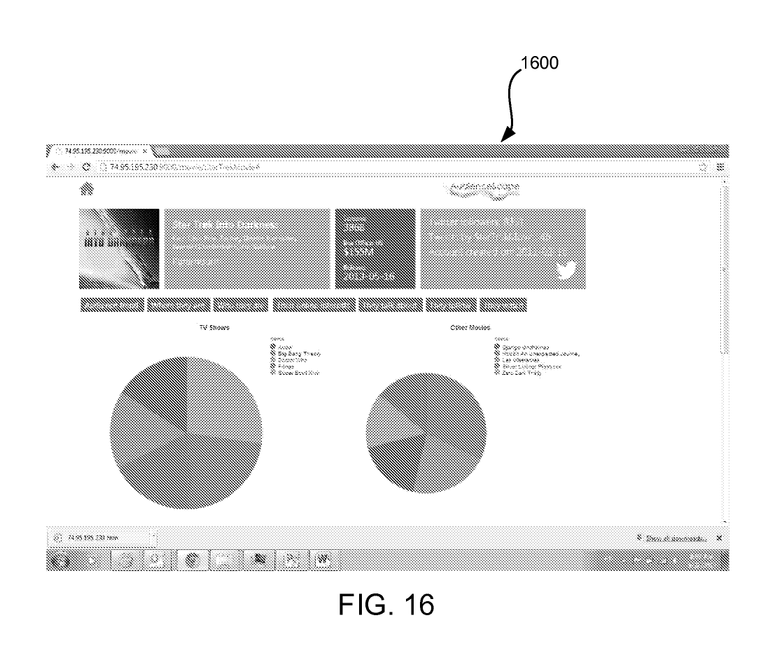

Referring now to FIG. 16, a “they watch” screen 1600 of the social media analytics platform 116 is shown. The “they watch” screen 1600 shows the top TV shows and other movies that the followers of the given or chosen movie watch. Potential uses of the “they watch” screen include, but are not limited to, identifying TV shows to advertise the chosen movie in or around and identifying actors from the TV shows or other movies to promote the chosen movie. It is to be appreciated that the data for the screen 1600 may be generated by the TV viewing habit extractor 220, as described above, and formatted for viewing by the data visualizer 224.

A system, apparatus and method for performing social media analytics for a movie have been described in relation to the above embodiments. The social media analytics platform 116 is provided to assist the customer 122 to make “social media informed” decisions about marketing, advertising and distribution strategies. For instance, the social media analytics platform 116 can help the customer 122 understand which audience should studios target for their advertising campaign, what are the audience interests at pre-release, opening weekend, blockbuster status, what other movies/TV shows is this audience interested in, and which brands would interest the audience for product placement. It is to be appreciated that the social media analytics platform 116 is scalable and cost effective. For example, in one implementation, a catalog of 100 movies released since May 2012 and tracked by the social media analytics platform 116 consists of about a hundred million users and one billion tweets.

It is to be appreciated that the various features shown and described are interchangeable, that is a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments of a system, apparatus and method for performing social media analytics for a movie (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure.

What is claimed is:

1. A method for performing social media analytics for a movie, the method comprising:
associating at least one user with the movie;
collecting, for the at least one associated user, at least one of user location data, user interest data, user-cited website data, and user television viewing habits data from a social networking or microblogging service;
processing the collected at least one user location data, user interest data, user-cited website data, and user television viewing habits data to generate movie campaign data, the movie campaign data including at least one of movie marketing data, movie advertising data, and movie distribution data; and
providing for display the at least one movie marketing data, movie advertising data, and movie distribution data in a user interface.

2. The method of claim 1, wherein the collecting of user interest data includes matching keywords from a profile of the at least one associated user to a predetermined list of user data.

3. The method of claim 2, wherein the predetermined list includes at least one of a list of professions, social roles, age and relationship status.

4. The method of claim 1, wherein the collecting of user interest data includes:
generating a hierarchical classification model from labeled interest data of a plurality of user profiles; and
labeling a profile of the at least one associated user with interest data based on the hierarchical classification model.

5. The method of claim 4, wherein the processing includes generating an audience interests profile for the movie by performing a frequency analysis along the hierarchy of the model.

6. The method of claim 1, wherein the processing includes:
performing a time series analysis on the collected data for a plurality of movies;
generating a predetermined number of representative clusters of time series trends for the plurality of movies; and
classifying the movie into one of the predetermined number of representative clusters to generate the movie campaign data.

7. The method of claim 6, wherein the generating the predetermined number of representative clusters is performed by a k-means clustering function.

8. The method of claim 1, wherein the collecting of user location data includes extracting at least one of latitude-longitude coordinates and a zip code from a user profile of the at least one associated user.

9. The method of claim 1, wherein the collecting of user location data includes preprocessing a location field entry of a profile of the at least one associated user and matching the preprocessed entry with a name of at least one location.

10. The method of claim 9, wherein the preprocessing includes at least one of direct querying the location field entry, splitting the location field entry into at least two words and resolving spelling errors in the location field entry using wildcard characters.

11. The method of claim 1, wherein the collecting of user-cited website data includes extracting a uniform resources locator (URL) from a message of the at least one associated user.

12. The method of claim 1, wherein the collecting of television viewing habits data includes extracting at least one of a television show name, a character name and a actor name from a message of the at least one associated user.

13. The method of claim 12, wherein the at least one of the television show name, the character name and the actor name is tagged in the message with a metadata tag.

14. An apparatus for performing social media analytics for a movie, the apparatus comprising:
a social media analytics module that associates at least one user with the movie, collects, for the at least one associated user, at least one of user location data, user interest data, user-cited website data, and user television viewing habits data from a social networking or microblogging service, and processes the collected at least one user location data, user interest data, user-cited website data, and user television viewing habits data to generate movie campaign data, the movie campaign data including at least one of movie marketing data, movie advertising data, and movie distribution data; and
a data visualizer that provides the at least one movie marketing data, movie advertising data, and movie distribution data for display in a user interface.

15. The apparatus of claim 14, further comprising a user interest extractor that collects the user interest data by matching keywords from a profile of the at least one associated user to a predetermined list of user data.

16. The apparatus of claim 15, wherein the predetermined list includes at least one of a list of professions, social roles, age and relationship status.

17. The apparatus of claim 14, further comprising a user interest extractor that collects user interest data by generating a hierarchical classification model from labeled interest data of a plurality of user profiles and labeling a profile of the at least one associated user with interest data based on the hierarchical classification model.

18. The apparatus of claim 17, wherein the social media analytics module generates an audience interests profile for the movie by performing a frequency analysis along the hierarchy of the model.

19. The apparatus of claim 14, further comprising a time series analyzer that performs a time series analysis on the collected data for a plurality of movies, generates a predetermined number of representative clusters of time series trends for the plurality of movies, and classifies the movie into one of the predetermined number of representative clusters to generate the movie campaign data.

20. The apparatus of claim 19, wherein the time series analyzer generates the predetermined number of representative clusters using a k-means clustering function.

21. The apparatus of claim 14, further comprising a location analyzer that collects the user location data by extracting at least one of latitude-longitude coordinates and a zip code from a user profile of the at least one associated user.

22. The apparatus of claim 14, further comprising a location analyzer that collects the user location data by preprocessing a location field entry of a profile of the at least one associated user and matching the preprocessed entry with a name of at least one location.

23. The apparatus of claim 22, wherein the location analyzer preprocesses the location field entry by at least one of direct querying the location field entry, splitting the location field entry into at least two words and resolving spelling errors in the location field entry using wildcard characters.

24. The apparatus of claim 14, further comprising a URL extractor that collects the user-cited website data by extracting a uniform resources locator (URL) from a message of the at least one associated user.

25. The apparatus of claim 14, further comprising a TV viewing habit extractor that collects the television viewing habits data by extracting at least one of a television show name, a character name and a actor name from a message of the at least one associated user.

26. The apparatus of claim 25, wherein the at least one of the television show name, the character name and the actor name is tagged in the message with a metadata tag.

27. An apparatus for performing social media analytics for a movie, the apparatus comprising:
means for associating at least one user with the movie;
means for collecting, for the at least one associated user, at least one of user location data, user interest data, user-cited website data, and user television viewing habits data from a social networking or microblogging service;
means for processing the collected at least one user location data, user interest data, user-cited website data, and user television viewing habits data to generate movie campaign data, the movie campaign data including at least one of movie marketing data, movie advertising data, and movie distribution data; and
means for providing for display the at least one movie marketing data, movie advertising data, and movie distribution data in a user interface.
